(19) United States
(12) Patent Application Publication
(10) Pub. No.: US 2002/0015552 A1
(43) Pub. Date: Feb. 7, 2002

(54) Optical wavelength router

(76) Inventors: Gayle R. Link, Powder Springs, GA (US); Calvin J. Martin, Atlanta, GA (US); Zelda Gills, Atlanta, GA (US); Derek Robertson, Smyrna, GA (US); Marcus W. Shute, Conyers, GA (US)

Correspondence Address: EDWARD O. KRUESSER, BROBECK PHLEGER & HARRISON, 12390 EL CAMINO REAL, SAN DIEGO, CA, 92130, US

(21) Appl. No.: 09/853,337

(22) Filed: May 10, 2001

Related U.S. Application Data
(60) Provisional application No. 60/222,082, filed on Aug. 1, 2000.
(60) Provisional application No. 60/222,155, filed on Aug. 1, 2000.
(60) Provisional application No. 60/245,367, filed on Nov. 2, 2000.
(60) Provisional application No. 60/234,571, filed on Sep. 22, 2000.

(51) Int. Cl. G02B 6/293; G02B 6/26

(52) U.S. Cl. 385/24; 385/16; 359/127

(57) ABSTRACT

An optical wavelength router receives multiplexed bundles of wavelength channels from input optical fibers, processes the channels, and outputs the processed channels onto output optical fibers. The router separates one or more of the channels from the received bundles and couples the separated channels into a switching fabric. The remaining, i.e., pass-through, channels are multiplexed with wavelength-converted “add” signals and input into channel combiners. The outputs of the switching fabric may be “dropped,” or coupled to the channel combiners for multiplexing with the pass-through and the add channels. A second switching fabric may be interposed between the output ports of the channel combiners and the output fibers, and a redundant path through the router may be included for path fault protection.

### RELATED APPLICATION

This application claims priority benefit of copending Provisional U.S. Patent Application Ser. No. 60/222,082, filed Aug. 1, 2000, entitled All-Optical Wavelength Router; of copending Provisional U.S. Patent Application Ser. No. 60/222,155, filed Aug. 1, 2000, entitled Wavelength Selectable Optical Add-Drop Multiplexer; of copending Provisional U.S. Patent Application Ser. No. 60/245,367, filed Nov. 2, 2000, entitled Wavelength Selective Waveguide Switch; of copending Provisional U.S. Patent Application Ser. No. 60/234,571, filed Sep. 22, 2000, entitled Wavelength Broadcasting Switch; of copending U.S. Patent Application Ser. No. 09/810,921 of the present applicants, entitled Optical Wavelength-Converting Apparatus, filed Mar. 16, 2001; and of copending U.S. patent application Ser. No. 09/811,327 of the present applicants, entitled Wavelength Selectable Optical Add-Drop Multiplexer, filed Mar. 16, 2001, which applications are hereby incorporated by reference for all purposes.

### BACKGROUND OF THE INVENTION

1. Field of the Invention

The present invention relates to wavelength routers and add-drop multiplexers for optical telecommunications networks.

2. Background

The explosive growth of telecommunications is, to a large degree, both a cause and an effect of the proliferation of fiber optic communication systems. Because of its many advantages, silica-based optical fiber has now been used for data transmission for approximately three decades. The advantages include low signal attenuation, immunity to electromagnetic interference (EMI), low crosstalk, fast propagation speed, physical flexibility, small size, and low weight all at a reasonable cost.

In a typical optical network, light modulated with data signals is coupled to a single mode fiber at a source node, transmitted to a destination node, possibly through several intermediate nodes, received at the destination node, demodulated and converted into an electrical data signal. “Light” in the present context includes infrared light; in fact, two of the more commonly used bands are centered around 1550 nanometers and 1310 nanometers, both lying in the near infrared region of the electromagnetic spectrum.

The continuing growth of telecommunication services impels service providers to accommodate ever-higher bandwidths requirements. Bandwidth available on a single wavelength channel (i.e., on a single transmission frequency) is limited by the modulation rates of available electro-optic modulators. Although the rates are increasing from 10 Gbits/s (OC-192/STM-64) to 40 Gbits/s (OC-768/STM-256), these numbers are just small fractions of the total bandwidth potentially available from an optical fiber, which is of the order of 20 Terahertz. As the need for more bandwidth exerts its relentless pressure, wavelength division multiplexing (WDM) systems have evolved to wring more carrying capacity from a single fiber. In WDM systems, separate data channels are transmitted through the same fiber on different wavelengths. As more and more distinct channels are squeezed into a single fiber, narrowband wavelength division multiplexing (NWDM) systems are replaced by dense wavelength division multiplexing (DWDM) systems having at the present time as many as 160 channels.

Generally, the grid of specific center wavelengths of channels that may be used in WDM systems is defined by ITU-T Standard G.692. (ITU-T standards are established by the Telecommunications Standardization Sector of International Telecommunication Union, a standard-setting organization based in Geneva.) A WDM system with channel separation or spacing of 100 GHz (≈0.8 nm) or less is considered to be a DWDM system.

The expansion of capacity of existing fiber networks through the use of “denser” WDM systems with more channels and narrower channel spacings may reduce the need to install more fiber. Moreover, the use of wavelength division multiplexing overcomes bandwidth limitations of the existing electronic end-point equipment, because each of the bandwidth channels can be processed separately. These, however, are not the only reasons for using WDM systems. Another reason is that such systems provide much needed flexibility in protocol and network topology selection.

Both topology and protocol selections are severely restricted in telecommunication systems where data of multiple channels are embedded in the same stream. An example of such transmission scheme is the synchronous optical network/synchronous digital hierarchy (SONET/SDH), a three-layer transport network architecture. In a SONET/SDH network, individual data flows, e.g., tributaries, are mapped into payloads and transported across the network's spans in envelopes, in a synchronous time division multiplexed (TDM) manner. The data flows of a SONET/SDH network must therefore be extracted from the envelopes before they can be switched individually.

In contrast, the data format and bit rate of each multiplexed wavelength channel can be independent from formats and rates of other channels propagating in the same fiber, because each multiplexed wavelength channel is independent from other wavelength channels. For example, one fiber can carry λ₁, λ₂, and λ₃ wavelength channels, where λ₁ is a 2.5 Gbit/s SONET OC-48 channel, λ₂ is a 10 Gbit/s SONET OC-192 channel, and λ₃ is a proprietary format channel. Unlike TDM data flows carried by the same wavelength channel, each of the three wavelength channels can be optically routed or switched. In other words, each wavelength channel is not transported as a payload of another communication layer, and therefore can be switched independent of other channels.

Independent switching avoids the need for opto-electronic (O-E) conversion of the aggregate data carried by the fiber, electronic processing of the data, and electro-optic (E-O) conversion for further transmission. The conversions and electronic processing typically require arrays of photodetectors and transponders. Photodetectors optically detect signals, and translate them into electronic signals that can be de-multiplexed and switched electronically. Transponders can then be employed to receive the detected and separated wavelength channels and translate them to different wavelengths for subsequent multiplexing and transmission through appropriate fibers.

The use of photodetector and transponder arrays is expensive. Even more important is that photodetectors and transponders are usually wavelength-specific components, requiring a priori knowledge of the wavelengths. Dynamic routing capability is therefore lost. And redundancy, often needed for reliability expected from modern providers of telecommunication services, becomes a rather costly one-to-one redundancy, instead of the more affordable N-to-M redundancy with N<M.

To benefit from the above-described advantages offered by WDM, many optical networks implement all-optical wavelength-based routing (or wavelength routing) architectures. Such networks can separately route distinct wavelength channels from node to node, across spans, as directed by the routing algorithms used. Optical wavelength routers perform the functions of spatially separating wavelength channels received as optical bundles of wavelength channels from one or more fibers, permuting the channels to desired associations between the received channels and output ports, and multiplexing the channels for transmission on fibers through the output ports.

A channel may be dropped or added at a terminal node, e.g., the channel's origination node, destination node, or an edge device node connecting the WDM network to a legacy network. Optical add-drop multiplexers perform the functions of adding and dropping selected wavelength channels, while allowing other wavelength channels to pass through multiplexer nodes.

Various wavelength routers and add-drop multiplexers are known in the art. It appears, however, that the known routers do not provide the ability to add wavelength-converted channels to the channels passing through a router node. Similarly, known add-drop multiplexers do not provide for wavelength conversion of the added channels, for wavelength routing of pass-through channels, or for path fault protection.

An add-drop multiplexer that simply adds new channels, without the capability to convert their wavelengths, imposes additional constraints on the routing algorithms of the optical network because the receivers and transponders associated with specific ports of the multiplexer are often fixed-wavelength devices. Assume, for example, that a wavelength channel needs to travel from node A to node B, and that the most efficient path for the wavelength channel is the span directly connecting node A to node B. Assume further that the wavelength associated with the port of the add-drop multiplexer that receives the channel is λ₁. If λ₁ is already used on the A-B span by another channel, the most efficient A-B route cannot be chosen. Thus, the channel either cannot be established, or it must be routed through a less efficient path.

Furthermore, channel assignments of different WDM systems, e.g., Lucent Wavestar™ and Nortel Networks OPTera™, may differ. Therefore, a channel received at a common node from one WDM system may be on a wavelength unavailable on the other WDM system. The received channel then cannot be routed across a span of the second network without conversion.

The shortcomings discussed above decrease the routing flexibility afforded by known wavelength routers and add-drop multiplexers. A need therefore exists for more flexible wavelength routers and add-drop multiplexers.

### SUMMARY OF THE INVENTION

The present invention is directed to an optical wavelength router for routing wavelength channels received in bundles of wavelength channels from optical fibers. In a representative embodiment, the router includes a spatial switching fabric and at least two main optical paths through the router.

Each path includes a wavelength filter, a wavelength conversion module, and a wavelength channel combiner. The wavelength filter receives a bundle of wavelength channels from an optical fiber carrying inbound traffic, separates one or more wavelength channels from the bundle, and passes through at least a subset of the optical channels of the bundle to the wavelength conversion module. The wavelength conversion module has a wavelength converter that receives an add channel and converts the received add channel to a new, transformed wavelength. The wavelength conversion module also has a multiplexing unit for multiplexing the wavelength channels received by the wavelength conversion module from the wavelength filter and the add wavelength channel converted by the wavelength converter. The wavelength channels multiplexed by the multiplexing unit are coupled to one input of the channel combiner.

For increased flexibility, the wavelength filters and converters may be made tunable, with the bandwidths and center wavelengths of the wavelength filters and the pump wavelengths of the wavelength converters being dynamically adjustable.

The spatial switching fabric includes a plurality of inputs coupled to the wavelength filters of the optical paths to receive the wavelength channels separated from the bundles of wavelength channels received from the fibers carrying inbound traffic, and a plurality of outputs to output the separated wavelength channels after they traverse the spatial switching fabric. Some or all of the outputs of the spatial switching fabric are coupled to the channel combiners of the optical paths. Each channel combiner combines or multiplexes the wavelength channels received by the combiner from an output of the spatial switching fabric and the channels multiplexed by the multiplexing unit coupled to the combiner, and sends the channels so combined to a fiber carrying outbound traffic.

The representative embodiment of the router may also employ a second spatial switching fabric between the outputs of channel combiners and the fibers carrying outbound traffic, optical amplifiers to boost the wavelength channels output by the channel combiners, and a redundant optical path through the router for path fault protection.

### BRIEF DESCRIPTION OF THE DRAWINGS

The present invention will now be explained, by way of examples only, with reference to the following description, appended claims, and accompanying figures where:

FIG. 1 illustrates a schematic diagram of an embodiment of a wavelength router in accordance with the present invention;

FIG. 2 illustrates a schematic diagram of another embodiment of a wavelength router that includes an output spatial switching fabric for increased switching flexibility of the router;

FIG. 3 illustrates a schematic diagram of a third embodiment of a wavelength router that includes an output spatial switching fabric, input switches, and an additional path through the router for path fault protection;

FIG. 4 illustrates a schematic diagram of an embodiment of a wavelength selection module that can be used in a wavelength router in accordance with the present invention;

FIG. 5A illustrates a schematic diagram of another embodiment of a wavelength selection module that can be used in a wavelength router in accordance with the present invention;

FIG. 5B illustrates a schematic diagram of a third embodiment of a wavelength selection module that can be used in a wavelength router in accordance with the present invention;

FIG. 6 illustrates a schematic diagram of a fourth embodiment of a wavelength selection module that can be used in a wavelength router in accordance with the present invention;

FIG. 7 illustrates a schematic diagram of an embodiment of a wavelength conversion module that can be used in a wavelength router in accordance with the present invention;

FIG. 8 illustrates a schematic diagram of a second embodiment of a wavelength conversion module that can be used in a wavelength router in accordance with the present invention; and

FIG. 9 illustrates an embodiment of a 3×3 switching fabric that can be used in a wavelength router in accordance with the present invention.

### DETAILED DESCRIPTION

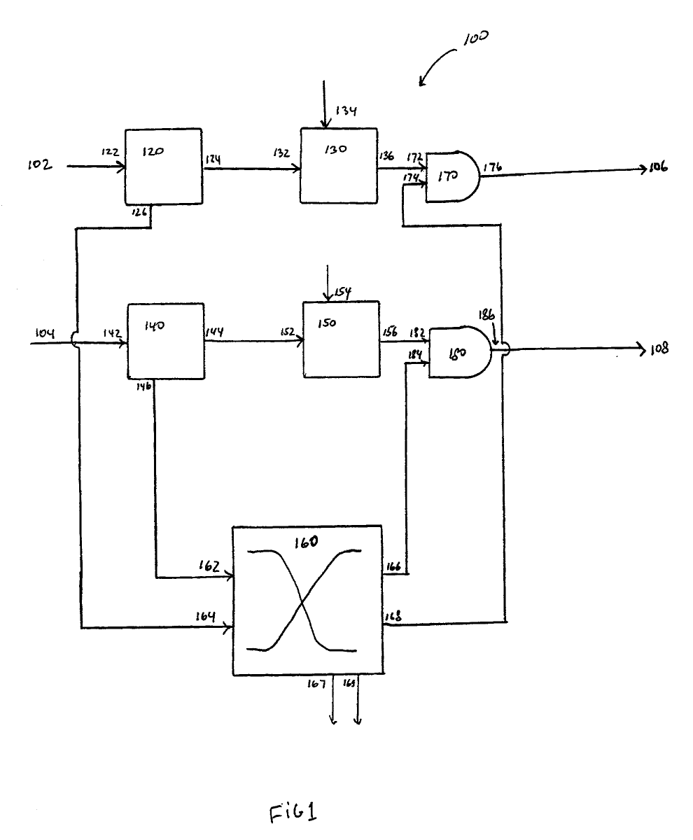

A wavelength router 100 in accordance with the present invention is schematically illustrated in FIG. 1. Single mode optical fibers 102 and 104 carry inbound WDM traffic comprising wavelength channels into the router 100, while fibers 106 and 108 carry outbound processed channels from the router 100. Each of the fibers 102 and 104 is optically coupled to one of wavelength selection modules 120 and 140. The wavelength selection module 120 receives multiplexed wavelength channels λ₁ . . . λ_{N} at an input 122. One or more of the multiplexed channels may be filtered out at an output 126, which is optically coupled to an input port 164 of a spatial switching fabric 160. The remaining, i.e., pass-through, channels are transmitted to an output 124, which is optically coupled to an input 132 of a wavelength conversion module 130. In addition to receiving the pass-through channels coupled to its input 132, the wavelength conversion module 130 receives an “add” signal having a wavelength λₐ at an input 134. The wavelength conversion module 130 spectrally transforms the add signal from the wavelength λₐ to a wavelength λᵢ that is not present among the wavelengths of the pass-through channels received at the input 132. The transformed channel is then multiplexed with the pass-through channels, and the multiplexed channels are outputted from port 136 of the wavelength conversion module 130.

Operation of the wavelength selection module 140 and wavelength conversion module 150 is similar to the operation of the modules 120 and 130 described in the preceding paragraph. The wavelength module 140 receives multiplexed wavelength channels λ′₁ . . . λ′_{N} at an input 142, filters out one or more of the received channels at an output 146, and optically couples the pass-through channels via an output 144 to an input 152 of the wavelength conversion module 150. The output 146 optically couples the channels filtered out in the wavelength selection module 140 to an input port 162 of the switching fabric 160. In addition to receiving the pass-through channels from the wavelength selection module 140, the wavelength conversion module 150 also receives an “add” signal having a wavelength λ′ₐ at an input 154. The wavelength conversion module 150 spectrally transforms the add signal from the wavelength λ′ₐ to a wavelength λ′ᵢ that is not present among the wavelengths of the pass-through channels received at the input 152. The transformed channel is then multiplexed with the pass-through channels received at the input 152, and the multiplexed channels are output from port 156 of the wavelength conversion module 150.

The switching fabric 160 receives the channels filtered out in the wavelength selection modules 120 and 140, and distributes them among its output ports 166, 167, 168, and 169. The output ports 167 and 169 are “drop” outputs, i.e., outputs that allow dropping of wavelength channels by the router. The output ports 166 and 168 are optically coupled to an input 184 of a channel combiner 180 and an input 174 of a channel combiner 170, respectively. Each of the channel combiners is also optically coupled to one of the wavelength conversion modules 130 and 150 to receive the pass-through channels from its respective wavelength conversion module. The channel combiner 170 combines the pass-through channels received from the wavelength conversion module 130 and the channel or channels received from the switching fabric 160, and outputs the combined channels through its output 176 onto the fiber 106. Analogously, the channel combiner 180 combines the pass-through channels received from the wavelength conversion module 150 and the channel or channels received from the switching fabric 160, and outputs the combined channels through its output 186 onto the fiber 108.

Although the channel combiners 170 and 180 have been represented as separate elements of the wavelength router 100, each channel combiner may be part of the wavelength conversion module from which the combiner receives the pass-through channels. This will be described in more detail below, in the context of discussing the wavelength conversion modules.

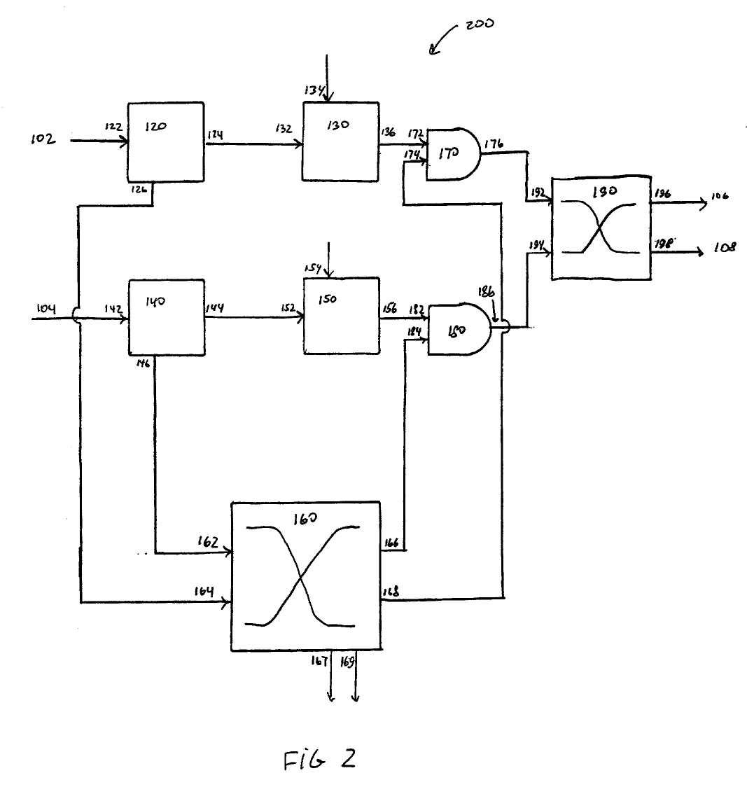

Another embodiment of a wavelength router in accordance with the present invention is illustrated in FIG. 2. Here, a wavelength router 200 includes a spatial switching fabric 190 in addition to all the elements of the wavelength router 100 of FIG. 1. The switching fabric 190 is interposed between the outputs of the channel combiners 170 and 180, and the fibers 106 and 108. This arrangement provides additional flexibility by allowing arbitrary routing of the pass-through channels.

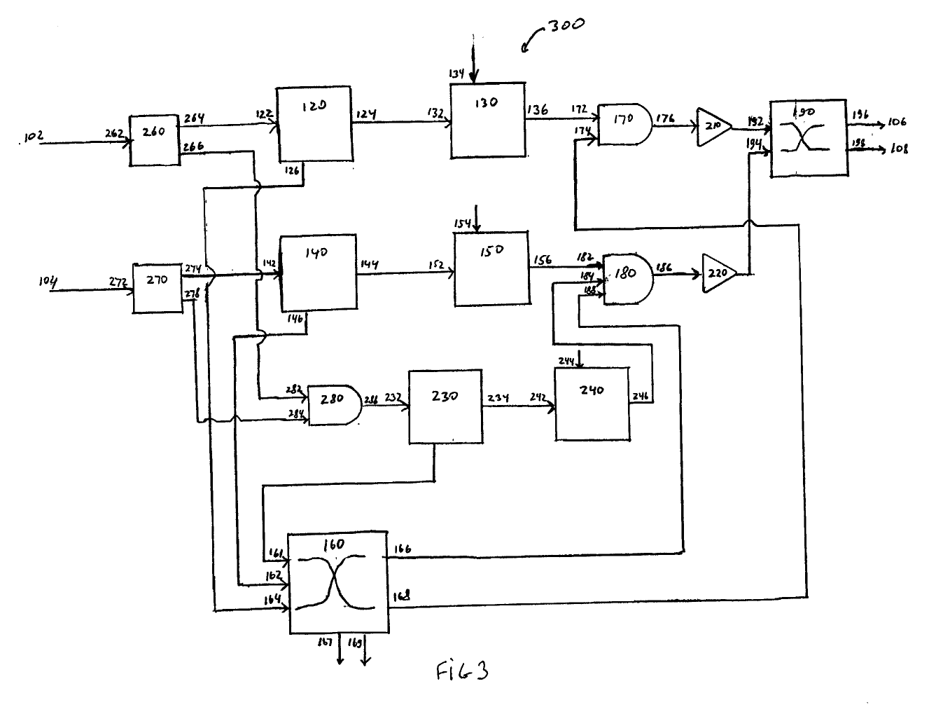

FIG. 3 illustrates a wavelength router 300 similar to the router 200 of FIG. 2, but includes two additional features. First, amplifiers 210 and 220 are interposed between the outputs of the channel combiners 170 and 180, and the inputs of the spatial switching fabric 190. The two amplifiers boost the power of the wavelength channels before the channels are transmitted through the fibers 106 and 108. Second, the router 300 provides path fault protection through redundancy.

In the wavelength router 300, the fiber 102 carries its inbound traffic to an input 262 of an optical switch 260. As illustrated, the switch 260 is a 1×2 switch with two outputs: 264 and 266. The output 264, which receives the wavelength channels from the fiber 102 in normal operation, is optically coupled to the input 122 of the wavelength selection module 120. When a fault occurs in the top optical path (i.e., the path that includes the modules 120 and 130, the combiner 170, and the amplifier 210), the switch 260 is reconfigured to couple the wavelength channels received from the fiber 102 into redundant optical path that includes a combiner 280, a wavelength selection module 230, and a wavelength conversion module 240.

The function of an optical switch 270 is similar to that of the switch 260. In other words, during normal operation it routes the wavelength channels from the fiber 104 to the optical path that is second from the top in FIG. 3; during fault conditions, it routes these channels to the redundant path.

Each of the routers 100-300 discussed above can be configured in a predetermined way or dynamically, by control signals sent to the router. Configuring in this context means determining the state of the switches 260 and 270 and of the switching fabrics 160 and 190, the specific wavelengths to which the wavelength conversion modules 130, 150, 230 convert the add signals, and the wavelengths and spacings of the channels filtered out by the wavelength selection modules 120, 140, and 240 may be predetermined or dynamically set by control signals sent to the router.

The number of optical path through the routers described can be increased beyond the two main path shown in FIGS. 1-3. For example, the router 300 can be expanded with an additional set of a switch, wavelength selection and conversion modules, a combiner, and an amplifier, so as to receive WDM channels from a third fiber carrying inbound traffic, and couple the processed channels into an additional fiber from a third output of the switching fabric 190. Likewise, the number of fibers carrying inbound traffic into the router need not be the same as the number of fibers carrying outbound traffic from the router.

A typical wavelength selection module used in the embodiments of the routers described in this document is essentially a filter. It may be made so that its center wavelength is tunable across a range of wavelengths, and with a variable bandwidth.

Several optical filters are known in the art. One example of an optical filter is a Bragg grating. A Bragg grating reflects a specific wavelength, allowing a broad band of surrounding wavelengths to pass through it. Thus, a wavelength selection module can be realized as a combination of a Bragg grating and a circulator for collecting the reflected wavelength channels.

A circulator is a multi-port device, with signals propagating in one direction. In a three-port optical circulator having a first port, a second port, and a third port, in this order, signals input at the first port are transmitted to the second port; and signals input at the second port are transmitted to the third port. But the signals are not transmitted in the reverse direction. For example, a signal input at the third port will not be transmitted to the second port.

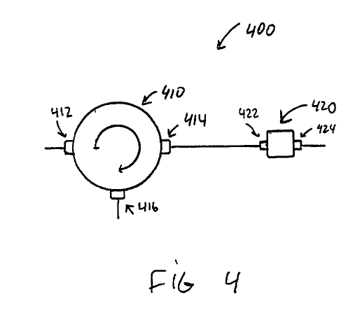

FIG. 4 illustrates an exemplary embodiment of a wavelength selection module 400 built with a circulator 410 and a Bragg grating 420. Port 412 of the circulator 410 serves as the input to the wavelength selection module 400, while port 416 of the circulator 410 is the “drop” output of the module. Output 424 of the Bragg grating serves as the pass-through output.

The filtering element in a wavelength selection module may include a Fabry-Perot resonator (an etalon), i.e., an optical resonator formed by mirrors. Fabry-Perot resonators can be tuned, for example, with low voltage piezoelectric actuators varying the gap between a resonator's mirrors by positioning one or more of the mirrors.

A Fabry-Perot filter can also be tuned by inserting a liquid crystal layer between the opposed mirrors of the filter, and applying an electric field across the layer. The electric field changes the refractive index of the liquid crystal material, thereby changing the resonant frequency of the cavity. Tunable Fabry-Perot liquid crystal filters have been described, for example, by Patel in U.S. Pat. Nos. 5,068,749 and 5,111,321, and by Kershaw in U.S. Pat. No. 6,154,591.

Another type of optical filter is a tunable acousto-optical filter. Acousto-optical filters operate based on elasto-optical effect, which is the phenomenon of physical stresses in a material causing changes in the material's refractive index. To take advantage of the elasto-optical effect, radio frequency waves are often used to generate surface acoustic waves in appropriate electro-optic medium, such as lithium niobate (LiNbO₃) crystal. The periodic compressions and rarefications of the surface acoustic waves create a temporary grating within the crystal. The temporary grating is tuned by controlling the radio frequency emitter.

In U.S. Pat. No. 6,157,025, Katagiri et al. teach an optical filter layer deposited on a disc-shaped transparent substrate. The filter layer is such that the center wavelength of the band-pass region varies with the angular dimension of the filter. Rotating the disc in relation to a light beam incident upon it exposes different angular portions of the disc to the beam, thereby changing the center wavelength of the filter. Different wavelengths can thus be selected by rotating the disc.

More generally, a tunable filter can be realized in an arrangement that allows physical movement of a filter element in some dimension in relation to an optical path of a beam of light being filtered. If the center wavelength of the band-pass region of the filter element varies with the dimension, the filter can be tuned by controlling an actuator that moves the filter element in the dimension of interest. The actuator may include a servomechanism, a position encoder, and a controller. The servomechanism moves the filter element, whose position the encoder senses and transmits to the controller. The controller receives the position data from the encoder and directs the servomechanism to place the filter element in accordance with an input control signal. See U.S. Pat. No. 6,111,997 issued to Jeong for examples of such tunable filters.

Yet another example of a tunable optical filter has been described by Starodubov in U.S. Pat. No. 6,058,226. Starodubov teaches an optical fiber including a core covered by a cladding. A grating within the core couples light either into the cladding or into a coating surrounding the fiber adjacent to the grating, depending on the resonant wavelength of the structure. The resonant wavelength is a function of the refractive index of the coating, which is made of a material whose refractive index varies with an externally controllable stimulus, such as an electric or a magnetic field.

A tunable optical filter somewhat similar to that taught by Starodubov has been disclosed by Baets et al. in U.S. Re-Examined Patent No. RE. 36,710. Baets's filter is also based on a tunable optical grating embedded in a multi-waveguide structure.

Another type of a tunable optical filter uses an optical splitter to divide a beam into several components. The several components are transmitted through different phase shifters, and then combined. The combined components interfere constructively or destructively, depending on their relative phases, which depend on the phase shifters and on the wavelength of the beam. Controlling the phase shifters tunes such interferometric filter to reject different wavelengths.

Still another type of optical filter uses a dielectric multi-layered filter element. Varying the optical lengths of the layers varies the passband of the filter. A simple method of varying the optical lengths of the layers is to change the angle of incidence of a beam upon the filter element. This can be done by, for example, rotating the filter element. See U.S. Pat. No. 5,481,402 issued to Cheng et al. for a polarization-independent tunable filter based on this principle.

Other tunable optical filters exist, including those based on polarization interference effects. But the precise type of filter or filters is not critical to the operation of the present invention.

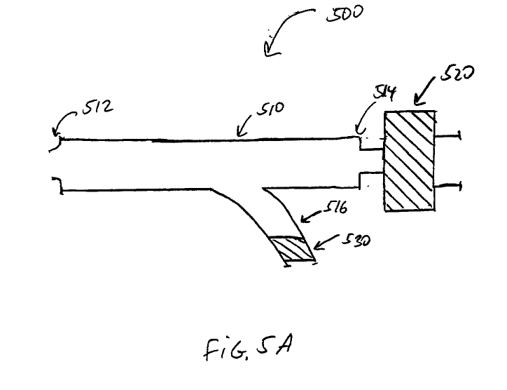

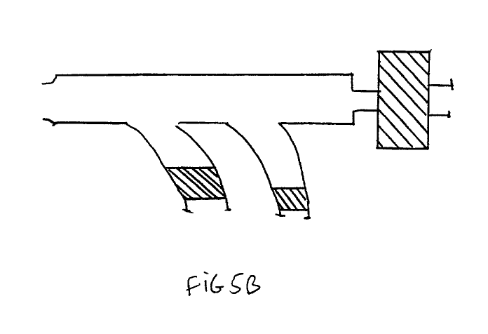

The wavelength selection module may also use a fused fiber optical power splitter/coupler in combination with one or more filters to perform the function of dropping one or more channels. This scheme is illustrated in FIG. 5A, where a wavelength selection module 500 includes a power splitter 510 and a filter 520. The aggregate multiplexed signal is fed into an input 512 of the splitter 510, which divides the power between a pass-through output 514 and a “drop” output 516. The-pass through output 514 is filtered by the filter 520 to remove the dropped wavelength λ_{d}, providing blocking operation. The output 516 may be filtered by a filter 530 to isolate the dropped wavelength λ_{d}.

Each of the filters 520 and 530 may be absorptive or reflective.

The power splitter 510 may have a plurality of drop outputs for dropping a plurality of channels. This is illustrated in FIG. 5B. In such case, the filter 520 may have several band-reject areas for filtering out multiple wavelength channels.

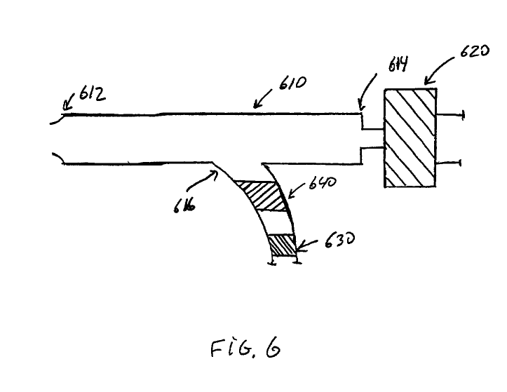

Because the power splitter inherently attenuates both the pass-through and the dropped channels, active fiber filler may be provided within the power splitter to amplify all the multiplexed channels, only the pass-through channels, or only the dropped channel. FIG. 6 illustrates the case with active fiber filler 640 located within a drop output 616 to amplify only the dropped wavelength channel. This arrangement allows the power splitter to be designed with a relatively small portion of the total power, e.g., less than 10%, to be diverted into the drop output 616, thereby minimizing the power losses incurred by the pass-through channels. At the same time, the effect on the signal-to-noise ratio of the dropped channel is also minimized, because the amplified spontaneous emissions (ASE) generated in the active fiber 640 are suppressed by a bandpass filter 630. To suppress the ASE better, the filter 630 may be made relatively narrow-band, with a passband just wide enough to transmit only the dropped channel or channels.

Typical active fiber is fiber doped with rare earth element ions. The doped fiber becomes fluorescent, meaning that it can absorb excitation energy at one wavelength and emit the absorbed energy at a different wavelength. For optical amplification, active fiber is excited or “pumped” by a source of light (an “optical pump”), e.g., a diode laser, at a wavelength other than the wavelengths of the multiplexed channels to be amplified, elevating the energy states of the fiber's constituent particles. When triggered by the propagating channels, the particles emit light at the channels' wavelengths, thereby amplifying the channels. Fluorescent dopants often used in active fiber of non-coherent optical systems operating in the 1310 nm and 1550 nm bands are erbium and praseodymium.

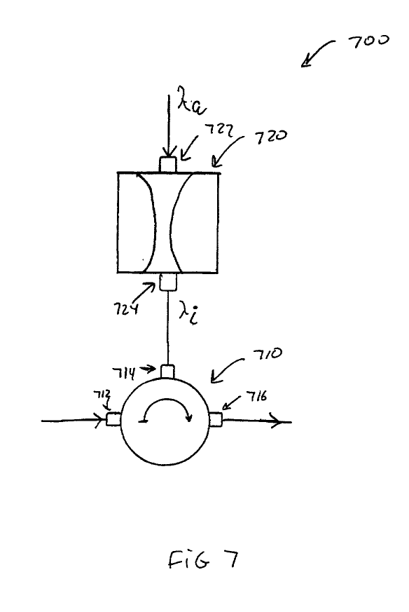

We turn now to a discussion of the wavelength conversion module. In FIG. 7, an embodiment of a wavelength conversion module 700 comprises a multiplexing unit 710 and a wavelength converting unit 720. The multiplexing unit 710 is depicted as a circulator, but may be any kind of an optical power combining mechanism, including, for example, a fused fiber optical power coupler.

Note that the multiplexing unit 710 may be able to combine or multiplex wavelength channels from more than two inputs. For example, if the multiplexing unit 710 has at least three inputs, it may also perform the function of the channel combiner that follows the wavelength conversion module. Thus, the channel combiner 170 may be incorporated into the wavelength conversion module 130, and the channel combiner 180 may be incorporated into the wavelength conversion unit 150.

The wavelength converting unit 720 transforms an “add” channel at a wavelength λₐ input at a port 722 into a channel at a different wavelength, such as a wavelength that is not present among the pass-through channels input into the module. Several methods of optical wavelength conversion are known to those of ordinary skill in the art, including the following: (1) difference frequency mixing, (2) cross-gain modulation, (3) cross-phase modulation, and (4) four-wave mixing.

Difference frequency mixing manipulates second-order nonlinearities in a quasi-phasematching structure to mix a modulated information-carrying signal at a free-space wavelength λₛ (corresponding to an angular frequency ωₛ) with a locally-generated continuous wave pump signal at a wavelength λₚ (corresponding to an angular frequency of ωₚ) to obtain a difference product at an angular frequency of ωₚ-ωₛ and a wavelength λₚ₋ₛ.

In this document we designate the wavelength corresponding to the angular frequency of ωₚ-ωₛ as λₚ₋ₛ, despite the fact that in the wavelength domain the frequency relationships are inverted.

The technique of optical difference frequency mixing is described more fully in the commonly-assigned patent application entitled Optical Wavelength-Converting Apparatus of the present inventors. Additional information is available in Martin M. Fejer et al., Quasi-Phase-Matched Second Harmonic Generation: Tuning and Tolerances, 28 J. QUANTUM ELEC. 2631-54 (IEEE 1992); and in U.S. Pat. No. 5,815,307 issued to Arbore et al. These sources are hereby incorporated by reference.

Cross-gain modulation and cross-phase modulation are two related techniques of wavelength conversion (or, more accurately, translation) that use nonlinear effects of semiconductor optical amplifiers (SOAs). In an SOA, light is amplified by stimulated emissions when the light propagates in an active region of a forward-biased p-n semiconductor junction. Using the nomenclature of the above example, when the modulated signal and the pump signal at a different wavelength enter an SOA, the presence of one wavelength will deplete the minority carrier concentration by the stimulated emission process, so that the population inversion experienced by the other signal will be reduced. The carrier populations are restored by spontaneous emissions from a high-energy state to a low-energy state, which process in many instances has a lifetime of the order of a nanosecond. As the input power of the first one of the two signals increases, carriers in the gain region of the SOA get depleted, resulting in gain-saturation with a concomitant reduction in the output power level of the second signal. Conversely, a reduction in the power level of the first signal results in an increase in the output power level of the second signal. Because carrier fluctuations happen quickly, typically in a picosecond timeframe, the gain experienced by the pump signal will respond to fluctuations in the information-carrying signal on a bit-by-bit basis. Thus, the amplified pump signal will be modulated with the logically-inverted pattern of the modulation of the information-carrying signal. This effect is known as wavelength conversion through cross-gain modulation.

In a typical cross-phase modulation wavelength conversion scheme, two SOAs are built into two arms of a Mach-Zehnder interferometer. The interferometer is adjusted so that the signals at the pump wavelength add destructively at its output, canceling each other. The modulated signal is injected into one of the arms of the Mach-Zehnder interferometer, modulating the refractive index experienced by the pump signal in the SOA of that arm. The interferometer is now unbalanced, and its output power level at the pump wavelength rises. Thus, the output of the interferometer becomes modulated by the data of the information-carrying signal.

For more information on cross-gain and cross-phase wavelength conversion techniques, the reader is referred to B. Mikkelson et al., Polarisation insensitive wavelength conversion of 10 Gbit/s signal with SOAs in a Michelson interferometer, 30 ELEC. LETTERS, 260-61 (February 1994); and to T. Durhus et al., All Optical Wavelength Conversion by SOA's in a Mach-Zehnder Configuration, 6 PHOTONICS TECH. LETTER, 53-55, (IEEE January 1994). Both articles are hereby incorporated by reference.

The fourth wavelength conversion technique is four-wave mixing. In short, the field intensity pattern of two interfering pump signal waves with free-space wavelength of λₚ form a grating in an SOA or in a nonlinear medium. The grating can be a population density grating or a refractive index grating. The modulated information-carrying signal with a wavelength λₛ and an angular frequency ωₛ is scattered by the grating, resulting in a scattered wave with an angular frequency equal to 2ωₚ-ωₛ. The modulation of the scattered wave corresponds to a spectral content that is a phase conjugate of the spectral content of the information-carrying signal.

For a more detailed treatment of the four-wave mixing technique, see Govind P. Agrawal, Population pulsations and non degenerate four-wave mixing in semiconductor laser and amplifiers, 5 OPT. SOC'Y AM. B, 147-59 (January 1988); and Jianhui Zhou et al., Four-Wave Mixing Wavelength Conversion Efficiency in Semiconductor Traveling-Wave Amplifiers Measured to 65 nm of Wavelength Shift, 6 PHOTONICS TECH. LETTERS, 984-87 (IEEE August 1994). These two articles are hereby incorporated by reference.

To increase the flexibility of the router, the pumps used in any of the conversion schemes can be made tunable, i.e., with variable wavelengths of the output signals, so that the added signal can be converted to one of a plurality of wavelength channels.

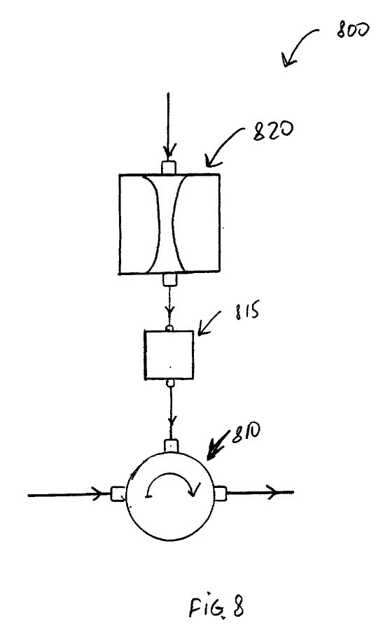

Returning to the discussion of the wavelength conversion module, an equalizer may be employed to bring the power levels of the added channel λᵢ and of the pass-through channels into relative parity. The equalizer may include an adjustable attenuator or an adjustable amplifier, and an optical power sensor. FIG. 8 illustrates a wavelength conversion module 800 having an equalizer 815 interposed between a power multiplexing unit 810 and a wavelength converting unit 820.

Several wavelength selection and conversion modules may be cascaded along a path in the router in accordance with the present invention. Such arrangement allows dropping and adding wavelength channels one after another, with each successive wavelength selection module dropping different channels, and each successive wavelength conversion module adding different channels.

Each of the channel combiners 170, 180, and 280 can be any kind of an optical power combining mechanism, including, for example, a fused fiber optical power coupler or a circulator the channel combiner 280 may also be an optical switch, for example an N×1 switch. Each of the channel combiners can include several cascaded combiners.

The amplifiers 210 and 220 can be realized as semiconductor optical amplifiers, or as active fiber within waveguides coupling the outputs of the channel combiners 170 and 180 to the inputs of the spatial switching fabric 190. The amplifiers can also be realized as active fiber within the channel combiners 170 and 180. Indeed, each of the amplifiers can be consolidated with its associated channel combiner and the multiplexing unit of the corresponding wavelength conversion module.

The optical switches 260 and 270 can be, for example, 1×2 or 2×2 optical switches. Each can be a mechanical switch, or a switch based on an optical power splitting device with controllable shutters or optical amplifiers in its output paths. Each switch can also be built as a micro-electro-mechanical system (MEMS), e.g., a micro-mechanical spatial light modulator array of small mirrors (or a single mirror) supported above silicon addressing circuitry by small hinges attached to a support post. The mirrors can be made to direct the light to different outputs as they rotate about their axes under control of, for example, electrostatic, electromagnetic, piezoelectric, or thermo-mechanical actuators. The switches can also be based on variable optical coupling between adjacent waveguiding structures. Further, the optical switches may be solid-state-based, using, for example, silicon, lithium niobate, or III-V semiconductors.

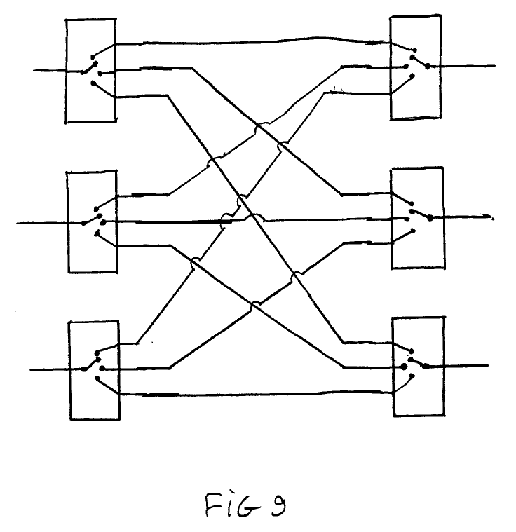

The switching fabrics 160 and 190 may be N×M fabrics constructed by cascading individual switches or smaller switching fabrics. A typical cascading arrangement for a 3×3 switching fabric is shown in FIG. 9. The switching fabrics can also be based on an array of gratings independently switchable between translucent and reflective states, so as to diffract or reflect light from different inputs into different outputs.

We have described the inventive router and some of its features in considerable detail for illustration purposes only. Neither the specific embodiments of the invention as a whole nor those of its features limit the general principles underlying the invention. In particular, the invention is not limited to specific regions of the light spectrum mentioned in this document, or to use in WDM optical transmission systems. The specific wavelength-converting techniques, filters, power splitters, couplers, switches, switching fabrics, and amplifiers described may be used in some embodiments, but not in others, without departure from the spirit and scope of the invention as set forth. Different geometries of the optical splitters and couplers also fall within the intended scope of the invention, and components such as the filters and the wavelength conversion modules may, but need not, be tunable. Moreover, in this document the expressions “coupled,” “optically coupled,” and their various inflections or derivatives are used broadly, referring to any type of optical signal transmission between elements; the “coupled” elements may be separated by intermediate devices and need not be directly connected to each other. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention, which function has been reserved for the following claims and their equivalents.

We claim:

1. An optical router for routing wavelength channels received in bundles of wavelength channels, the router comprising:
a plurality of wavelength filters, one filter of the plurality of wavelength filters per bundle, each filter of the plurality of wavelength filters being capable of separating one or more wavelength channels from the bundle associated with the filter;
a plurality of wavelength converters, one converter of the plurality of wavelength converters per bundle, each converter being capable of receiving an add wavelength channel and converting the received add wavelength channel to a transformed wavelength;
a plurality of multiplexing units, one multiplexing unit of the plurality of multiplexing units per bundle, each multiplexing unit of the plurality of multiplexing units being capable of multiplexing at least a subset of channels of the bundle associated with said each multiplexing unit and the add wavelength channel converted by the converter associated with the bundle that is associated with said each multiplexing unit;
a first spatial switching fabric comprising a plurality of inputs and a plurality of outputs, the inputs of the first spatial switching fabric being coupled to the plurality of wavelength filters to receive the separated one or more wavelength channels; and
a plurality of channel combiners, one channel combiner of the plurality of channel combiners per multiplexing unit of the plurality of multiplexing units, each channel combiner of the plurality of channel combiners being coupled to a different one of the outputs of the plurality of outputs of the first spatial switching fabric, said each channel combiner being capable of receiving and multiplexing channels received from the corresponding output of the plurality of outputs of the first spatial switching fabric and the channels multiplexed by the multiplexing unit associated with said each channel combiner.

2. An optical router according to claim 1, wherein said each filter of the plurality of wavelength filters comprises a tunable band pass filter capable of separating different one or more wavelength channels.

3. An optical router according to claim 2, wherein said each converter of the plurality of wavelength converters comprises a tunable pump source capable of producing pump output at different wavelengths to enable said each converter to convert the received add wavelength channel to different transformed wavelengths.

4. An optical router according to claim 1, wherein said each wavelength filter of the plurality of wavelength filters comprises a circulator having consecutive first, second, and third ports, and a Bragg grating coupled to the third port of the circulator.

5. An optical router according to claim 4, wherein the Bragg grating of said each wavelength filter is a tunable Bragg grating capable of being adjusted to reflect different wavelengths.

6. An optical router according to claim 1, wherein said each wavelength filter of the plurality of wavelength filters comprises:
a fused fiber optical power splitter comprising an input path capable of receiving the bundle associated with said each wavelength filter, a pass-through output path for outputting at least the subset of channels of the bundle associated with said each wavelength filter, and a first separated output path capable of outputting the one or more wavelength channels separated from the bundle associated with said each wavelength filter; and
a first band pass filtering element coupled to the first separated output path so that the one or more wavelength channels separated from the bundle associated with said each wavelength filter pass through the first band pass filtering element, the first band pass filtering element having a first passband.

7. An optical router according to claim 6, wherein:
the fused fiber optical power splitter of said each wavelength filter further comprises a second separated output path capable of outputting the one or more wavelength channels separated from the bundle associated with said each wavelength filter; and
said each wavelength filter further comprises a second band pass filtering element coupled to the second separated output path so that the one or more wavelength channels separated from the bundle associated with said each wavelength filter pass through the second band pass filtering element, the second band pass filtering element having a second passband.

8. An optical router according to claim 6, wherein said each wavelength filter further comprises active fiber filler in the first separated output path, the active fiber filler being for amplifying the one or more wavelength channels separated from the bundle associated with said each wavelength filter.

9. An optical router according to claim 6, wherein said each wavelength filter further comprises a pass-through band reject filtering element coupled to the pass-through output path for removing the one or more wavelength channels separated from the bundle associated with said each wavelength filter from the subset of channels of the bundle associated with said each wavelength filter.

10. An optical router according to claim 9, wherein:
the pass-through band reject filtering element of said each wavelength filter comprises a tunable pass through filtering element capable of being adjusted to reject different wavelengths; and
the first band pass filtering element comprises a first tunable filtering element capable of being adjusted to transmit different wavelengths.

11. An optical router according to claim 1, wherein said each converter of the plurality of wavelength converters comprises a difference frequency mixer.

12. An optical router according to claim 11, wherein:
said each filter of the plurality of wavelength filters comprises a tunable band pass filter capable of separating different one or more wavelength channels; and
the difference frequency mixer of said each converter of the plurality of wavelength converters comprises a tunable pump source capable of producing pump output at different wavelengths to enable said each converter to convert the received add wavelength channel to different transformed wavelengths.

13. An optical router according to claim 1, wherein said each converter of the plurality of wavelength converters comprises a cross-gain modulator.

14. An optical router according to claim 13, wherein:
said each filter of the plurality of wavelength filters comprises a tunable band pass filter capable of separating different one or more wavelength channels; and
the cross-gain modulator of said each converter of the plurality of wavelength converters comprises a tunable pump source capable of producing pump output at different wavelengths to enable said each converter to convert the received add wavelength channel to different transformed wavelengths.

15. An optical router according to claim 1, wherein said each converter of the plurality of wavelength converters comprises a cross-phase modulator.

16. An optical router according to claim 13, wherein:
said each filter of the plurality of wavelength filters comprises a tunable band pass filter capable of separating different one or more wavelength channels; and
the cross-phase modulator of said each converter of the plurality of wavelength converters comprises a tunable pump source capable of producing pump output at different wavelengths to enable said each converter to convert the received add wavelength channel to different transformed wavelengths.

17. An optical router according to claim 1, wherein said each converter of the plurality of wavelength converters comprises a four-wave mixer.

18. An optical router according to claim 13, wherein:
said each filter of the plurality of wavelength filters comprises a tunable band pass filter capable of separating different one or more wavelength channels; and
the four-wave mixer of said each converter of the plurality of wavelength converters comprises a tunable pump source capable of producing pump output at different wavelengths to enable said each converter to convert the received add wavelength channel to different transformed wavelengths.

19. An optical router according to claim 1, further comprising a plurality of power equalizers, one equalizer per wavelength converter of the plurality of wavelength converters, each equalizer being interposed between the converter associated with said each equalizer and the multiplexing unit corresponding to the wavelength converter associated with said each equalizer.

20. An optical router according to claim 1, wherein said each multiplexing unit comprises a circulator.

21. An optical router according to claim 3, wherein said each multiplexing unit comprises a circulator.

22. An optical router according to claim 1, wherein said each multiplexing unit comprises a fused fiber optical power splitter.

23. An optical router according to claim 3, wherein said each multiplexing unit comprises a fused fiber optical power splitter.

24. An optical router according to claim 1, further comprising a second spatial switching fabric comprising a plurality of inputs and a plurality of outputs, one input of the plurality of inputs of the second spatial switching fabric per channel combiner of the plurality of channel combiners, each input of the plurality of inputs of the second spatial switching fabric being coupled to the channel combiner associated with said each input of the plurality of inputs of the second spatial switching fabric to receive the channels multiplexed by the channel combiner associated with said each input of the plurality of inputs of the second spatial switching fabric.

25. An optical router according to claim 24, wherein:
said each filter of the plurality of wavelength filters comprises a tunable band pass filter capable of separating different one or more wavelength channels; and
said each converter of the plurality of wavelength converters comprises a tunable pump source capable of producing pump output at different wavelengths to enable said each converter to convert the received add wavelength channel to different transformed wavelengths.

26. An optical router according to claim 24, further comprising:
a plurality of optical amplifiers, one amplifier of the plurality of amplifiers per channel combiner, each amplifier of the plurality of amplifiers being interposed between the channel combiner associated with said each amplifier and the input of the plurality of inputs of the second spatial switching fabric associated with the channel combiner that is associated with said each amplifier.

27. An optical router according to claim 24, further comprising:
a plurality of optical switches, one switch of the plurality of switches per wavelength filter of the plurality of wavelength filters, each switch of the plurality of switches comprising an input, a first switch output, and a second switch output, said each switch being capable of receiving the bundle associated with the filter that is associated with said each switch and selectively transmitting the bundle associated with the filter that is associated with said each switch to the first or the second switch output of said each switch;
a redundant path channel combiner comprising an output and inputs coupled to the second switch outputs of the plurality of optical switches;
a redundant path wavelength filter capable of separating one or more wavelength channels from one of the bundles of wavelength channels;
a redundant path wavelength converter capable of receiving a redundant path add channel and converting the received redundant path add channel to a different wavelength;
a redundant path multiplexing unit coupled to the redundant path wavelength filter and to the redundant path wavelength converter, the redundant path multiplexing unit being capable of multiplexing at least a subset of channels of the one of the bundles of wavelength channels and the converted redundant path add channel;
wherein:
the plurality of channel combiners comprises a first channel combiner, the first channel combiner being coupled to the redundant path multiplexing unit; and
the first channel combiner is capable of multiplexing the channels received by the first channel combiner from the output of the first spatial switching fabric corresponding to the first channel combiner, the channels multiplexed by the multiplexing unit associated with the first channel combiner, and the channels multiplexed by the redundant path multiplexing unit.

28. An optical router according to claim 27, wherein said each converter of the plurality of wavelength converters comprises a difference frequency mixer.

29. An optical router according to claim 28, wherein:
said each filter of the plurality of wavelength filters comprises a tunable band pass filter capable of separating different one or more wavelength channels; and
the difference frequency mixer of said each converter of the plurality of wavelength converters comprises a tunable pump source capable of producing pump output at different wavelengths to enable said each converter to convert the received add wavelength channel to different transformed wavelengths.

30. An optical router according to claim 27, wherein said each converter of the plurality of wavelength converters comprises a cross-gain modulator.

31. An optical router according to claim 30, wherein:
said each filter of the plurality of wavelength filters comprises a tunable band pass filter capable of separating different one or more wavelength channels; and
the cross-gain modulator of said each converter of the plurality of wavelength converters comprises a tunable pump source capable of producing pump output at different wavelengths to enable said each converter to convert the received add wavelength channel to different transformed wavelengths.

32. An optical router according to claim 27, wherein said each converter of the plurality of wavelength converters comprises a cross-phase modulator.

33. An optical router according to claim 32, wherein:
said each filter of the plurality of wavelength filters comprises a tunable band pass filter capable of separating different one or more wavelength channels; and
the cross-phase modulator of said each converter of the plurality of wavelength converters comprises a tunable pump source capable of producing pump output at different wavelengths to enable said each converter to convert the received add wavelength channel to different transformed wavelengths.

34. An optical router according to claim 27, wherein said each converter of the plurality of wavelength converters comprises a four-wave mixer.

35. An optical router according to claim 34, wherein:
said each filter of the plurality of wavelength filters comprises a tunable band pass filter capable of separating different one or more wavelength channels; and
the four-wave mixer of said each converter of the plurality of wavelength converters comprises a tunable pump source capable of producing pump output at different wavelengths to enable said each converter to convert the received add wavelength channel to different transformed wavelengths.

36. An optical router according to claim 1, wherein said each filter of the plurality of wavelength filters comprises a tunable band pass filter characterized by a passband with an adjustable bandwidth and an adjustable center wavelength, whereby said each filter of the plurality of wavelength filters is capable of separating a first wavelength channel of the one or more wavelength channels at different wavelengths and with variable channel separation.

37. An optical router according to claim 36, wherein said each converter of the plurality of wavelength converters comprises a tunable pump source capable of producing pump output at different wavelengths to enable said each converter to convert the received add wavelength channel to different transformed wavelengths.

38. An optical router for routing wavelength channels received in bundles of wavelength channels, the router comprising:
a plurality of wavelength filters, one filter of the plurality of wavelength filters per bundle, each filter of the plurality of wavelength filters being capable of separating one or more wavelength channels from the bundle associated with the filter;
a plurality of wavelength converters, one converter of the plurality of wavelength converters per bundle, each converter being capable of receiving an add wavelength channel and converting the received add wavelength channel to a transformed wavelength;
a first spatial switching fabric comprising a plurality of inputs and a plurality of outputs, the inputs of the first spatial switching fabric being coupled to the plurality of wavelength filters to receive the separated one or more wavelength channels;
a plurality of multiplexing units, one multiplexing unit of the plurality of multiplexing units per bundle, each multiplexing unit of the plurality of multiplexing units being coupled to a respective output of the plurality of outputs of the first spatial switching fabric, said each multiplexing unit of the plurality of multiplexing units being capable of multiplexing at least a subset of channels of the bundle associated with said each multiplexing unit, the add wavelength channel converted by the converter associated with the bundle that is associated with said each multiplexing unit, and channels received from the respective output of the plurality of outputs of the first spatial switching fabric.

39. An optical router according to claim 38, wherein said each filter of the plurality of wavelength filters comprises a tunable band pass filter capable of being adjusted to separate different one or more wavelength channels.

40. An optical router according to claim 39, wherein said each converter of the plurality of wavelength converters comprises a tunable pump source capable of producing pump output at different wavelengths to enable said each converter to convert the received add wavelength channel to different transformed wavelengths.

41. An optical router according to claim 38, wherein said each multiplexing unit of the plurality of multiplexing units comprises a fused fiber optical power splitter.

42. An optical router according to claim 41, wherein the fused fiber optical power splitter of said each multiplexing unit of the plurality of multiplexing units comprises active fiber filler capable of amplifying the wavelength channels multiplexed by said each multiplexing unit of the plurality of multiplexing units.

43. A router comprising:
a first wavelength selection module comprising an input port capable of receiving a first plurality of wavelength channels, a first wavelength filter capable of separating a first separated channel from the first plurality of wavelength channels, and a first pass-through output port for outputting wavelength channels of the first plurality of wavelength channels;
a second wavelength selection module comprising an input port capable of receiving a second plurality of wavelength channels, a second wavelength filter capable of separating a second separated channel from the first plurality of wavelength channels, and a second pass-through output port for outputting wavelength channels of the second plurality of wavelength channels;
a first wavelength conversion module comprising a first wavelength converter capable of receiving a first add channel at a first add wavelength and converting the first add channel to a first converted wavelength, a first multiplexing unit coupled to the first pass-through port and to the first wavelength converter, the first multiplexing unit being capable of multiplexing the wavelength channels of the first plurality of wavelength channels received from the first pass-through port and the converted first add channel;
a second wavelength conversion module comprising a second wavelength converter capable of receiving a second add channel at a second add wavelength and converting the second add channel to a second converted wavelength, a second multiplexing unit coupled to the second pass-through port and to the second wavelength converter, the second multiplexing unit being capable of multiplexing the wavelength channels of the second plurality of wavelength channels received from the second pass-through port and the converted second add channel;
a first spatial switching fabric comprising a first input coupled to the first wavelength selection module to receive the first separated channel, a second input coupled to the second wavelength selection module to receive the second separated channel, and a plurality of outputs comprising a first output and a second output;
a first channel combiner coupled to the first output of the plurality of outputs of the first spatial switching fabric and to the first wavelength conversion module, the first channel combiner being capable of receiving and multiplexing wavelength channels from the first output of the first spatial switching fabric and the channels multiplexed by the first multiplexing unit; and
a second channel combiner coupled to the second output of the plurality of outputs of the first spatial switching fabric and to the second wavelength conversion module, the second channel combiner being capable of receiving and multiplexing wavelength channels from the second output of the first spatial switching fabric and the channels multiplexed by the second multiplexing unit.

44. A router according to claim 43, wherein:
the first wavelength filter comprises a first tunable band pass filtering element capable of being adjusted to separate the first separated channel in a range of wavelengths; and
the second wavelength filter comprises a second tunable band pass filtering element capable of being adjusted to separate the second separated channel in a range of wavelengths.

45. A router according to claim 44, wherein the first wavelength converter comprises a tunable pump source capable of producing pump output at different wavelengths to enable said each converter to convert the first add channel to a first converted wavelength in a range of wavelengths.

46. An optical wavelength router comprising:
first wavelength selection means for receiving a first plurality of wavelength channels from a first in fiber, and for selectively separating at least a first channel from the first plurality of wavelength channels;
second wavelength selection means for receiving a second plurality of wavelength channels from a second in fiber, and for selectively separating at least a second channel from the second plurality of wavelength channels;
first wavelength conversion means for receiving a first add wavelength channel at a first add wavelength and converting the first add wavelength channel to a first transformed wavelength;
second wavelength conversion means for receiving a second add wavelength channel at a second add wavelength and converting the second add wavelength channel to a second transformed wavelength;
first wavelength multiplexing means coupled to the first wavelength conversion means and to the first wavelength selection means, the first wavelength multiplexing means being for multiplexing at least a first subset of wavelength channels of the first plurality of wavelength channels and the converted first add wavelength channel;
second wavelength multiplexing means coupled to the second wavelength conversion means and to the second wavelength selection means, the second wavelength multiplexing means being for multiplexing at least a second subset of wavelength channels of the second plurality of wavelength channels and the converted second add wavelength channel;
first spatial switching means comprising a first input, a second input, a first output, and a second output, the first spatial switching means being for routing wavelength channels from the inputs of the first spatial switching means to the outputs of the first spatial switching means;
first channel combiner means for combining wavelength channels appearing at the first output of the first spatial switching means and the wavelength channels multiplexed by the first wavelength multiplexing means; and
second channel combiner means for combining wavelength channels appearing at the second output of the second spatial switching means and the wavelength channels multiplexed by the second wavelength multiplexing means.

47. An optical wavelength router according to claim 46, wherein:
the first wavelength selection means comprises first tunable band pass filter means capable of being adjusted to separate the first channel in a range of wavelengths; and
the second wavelength selection means comprises second tunable band pass filter means capable of being adjusted to separate the second channel in a range of wavelengths.

48. An optical wavelength router according to claim 47, wherein the first wavelength conversion means comprises a first tunable wavelength conversion means for converting the first add wavelength channel to the first transformed wavelength in a range of wavelengths.

49. An optical wavelength router according to claim 48, wherein the first tunable wavelength conversion means comprises a difference frequency mixer means for wavelength conversion.

50. An optical wavelength router according to claim 48, wherein the first tunable wavelength conversion means comprises a cross-gain modulator means for wavelength conversion.

51. An optical wavelength router according to claim 48, wherein the first tunable wavelength conversion means comprises a cross-phase modulator means for wavelength conversion.

52. An optical wavelength router according to claim 48, wherein the first tunable wavelength conversion means comprises a four-wave mixer means for wavelength conversion.

53. An optical wavelength router according to claim 48, further comprising second spatial switching means comprising a first input, a second input, and a plurality of outputs, the first input of the second spatial switching means being coupled to the first channel combiner means to receive the wavelength channels combined by the first channel combiner means, the second input of the second spatial switching means being coupled to the second channel combiner means to receive the wavelength channels combined by the second channel combiner means, the second spatial switching means being for routing the wavelength channels combined by the first and the second channel combiner means from the first and second inputs of the second spatial switching means to the plurality of outputs of the second spatial switching means.

54. An optical wavelength router according to claim 53, further comprising means for providing router path fault protection through redundancy.

55. An optical wavelength router according to claim 54, further comprising:
first means for amplifying wavelength channels interposed between the first channel combiner means and the first input of the second spatial switching means; and
second means for amplifying wavelength channels interposed between the second channel combiner means and the second input of the second spatial switching means.

56. An optical wavelength router according to claim 46, wherein:
the first wavelength selection means comprises first tunable band pass filter means characterized by a first adjustable center wavelength and a first adjustable bandwidth; and
the second wavelength selection means comprises second tunable band pass filter means characterized by a second adjustable center wavelength and a second adjustable bandwidth.

57. An optical wavelength router according to claim 56, wherein the first wavelength conversion means comprises a first tunable wavelength conversion means for converting the first add wavelength channel to the first transformed wavelength in a range of wavelengths.
